(19) United States
(12) Patent Application Publication
(10) Pub. No.: US 2013/0139140 A1
(43) Pub. Date: May 30, 2013

(54) Method and Apparatus for Mobile Mesh Network Vehicular Software Updating

(71) Applicants: Jayanthi Rao, West Bloomfield, MI (US); Thomas J. Giuli, Ann Arbor, MI (US); Krishnaswamy Venkatesh Prasad, Ann Arbor, MI (US)

(72) Inventors: Jayanthi Rao, West Bloomfield, MI (US); Thomas J. Giuli, Ann Arbor, MI (US); Krishnaswamy Venkatesh Prasad, Ann Arbor, MI (US)

(73) Assignee: FORD GLOBAL TECHNOLOGIES, LLC, Dearborn, MI (US)

(21) Appl. No.: 13/305,966

(22) Filed: Nov. 29, 2011

(51) Int. Cl. G06F 9/44; G06F 15/16

(52) U.S. Cl. 717/170; 709/217; 717/168; 709/219

(57) ABSTRACT

A computer implemented method includes wirelessly receiving data from a proximate vehicle computing system, the data comprising at least a portion of a complete software process. The method also includes storing the received data and evaluating whether the stored data, in conjunction with any previously stored data, constitutes the entire complete software process. The method further includes executing the entire complete software process, conditional on the evaluating.

### TECHNICAL FIELD

The illustrative embodiments generally relate to a method and apparatus for mobile mesh network software updating.

### BACKGROUND

Many current vehicles come equipped with integrated computing systems. Controlling numerous aspects of the vehicle, and providing additional features including, but not limited to, phone application integration and infotainment, these computing systems provide a new level of occupant experience for a driver and passengers.

Like other, non-vehicular computing systems, many of these vehicular computing systems have functional aspects dictated by software modules. And, like software modules on non-vehicular computing systems, these vehicular software modules may periodically be updated by a provider. Unlike non-vehicular computing systems, however, these software modules are currently typically updated by either a dealer/maintenance worker, or by downloading an update to a portable drive and interfacing the drive with a vehicle input. This provides for an added layer of security when updating the system.

U.S. Patent Application Publication No. 2008/0162036 discusses: “Method and arrangement for providing map information to an operator of a vehicle includes forming a map database to reside on the vehicle, e.g., after installation on the vehicle, and which includes for example, data about lanes that the vehicle can travel on locations of a boundary or edges of the travel lanes, data about traffic control devices in the database, data about guard rails along travel lanes and/or data about inanimate objects such as poles and trees alongside the travel lanes. The database is managed to ensure that it has current information about a travel lane on which the vehicle is currently situated. This may entail establishing wireless communications to the vehicle to enable data to be provided to the database, e.g., from other vehicles and/or from infrastructure.”

U.S. Pat. No. 7,848,278 discusses: “An ad-hoc wireless network with a roadside network unit (RSU) and a local peer group (LPG). The LPG is formed from a plurality of moving vehicles. The LPG includes a group header node (GH) for managing the LPG. The GH is elected from one of the moving vehicles. The LPG further includes group nodes (GN) designated from the remaining moving vehicles in a given area. Each of the moving vehicles, whether the GH or the GN, communicates with other using routing paths created based upon a first control packet broadcast from the GH and a second control packet broadcast from each of the GN. Each moving vehicle communicates with the RSU using a routing paths created based upon a beacon broadcast by the RSU and a reply signal from each of the moving vehicles. The RSU can also be a member of the LPG and act as GN or GH.”

Although ad-hoc networking between vehicles is known (see also, e.g., DE 102004017602) there are many applications for vehicular ad-hoc networks that have not yet been considered.

### SUMMARY

In a first illustrative embodiment, a computer implemented method includes wirelessly receiving data from a proximate vehicle computing system, the data comprising at least a portion of a complete software process. The method also includes storing the received data and evaluating whether the stored data, in conjunction with any previously stored data, constitutes the entire complete software process. The method further includes executing the entire complete software process, conditional on the evaluating.

In a second illustrative embodiment, a system includes a plurality of vehicles, each having a transceiver and a vehicle computing system. The respective vehicle computing systems are configured to transfer and store portions of a software update therebetween, such that one or more of the vehicles eventually stores an entire version of the software update, having been completely received in portion form from more than one of the plurality of vehicles.

In a third illustrative embodiment, a computer implemented method includes receiving test code from a proximate vehicle computing system. The method includes executing the test code to produce a test result. The method also includes reporting the test result back to a known remote server and transmitting the received test code to a different proximate vehicle computing system.

### BRIEF DESCRIPTION OF THE DRAWINGS

FIG. 1 shows an illustrative vehicle computing system;

FIG. 2 shows an illustrative example of a software update distribution process;

FIG. 3A shows an illustrative example of a software transmission process;

FIG. 3B shows an illustrative example of a second software transmission process;

FIG. 4 shows an illustrative example of a software update process; and

FIG. 5 shows an illustrative example of a mesh network polling process.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

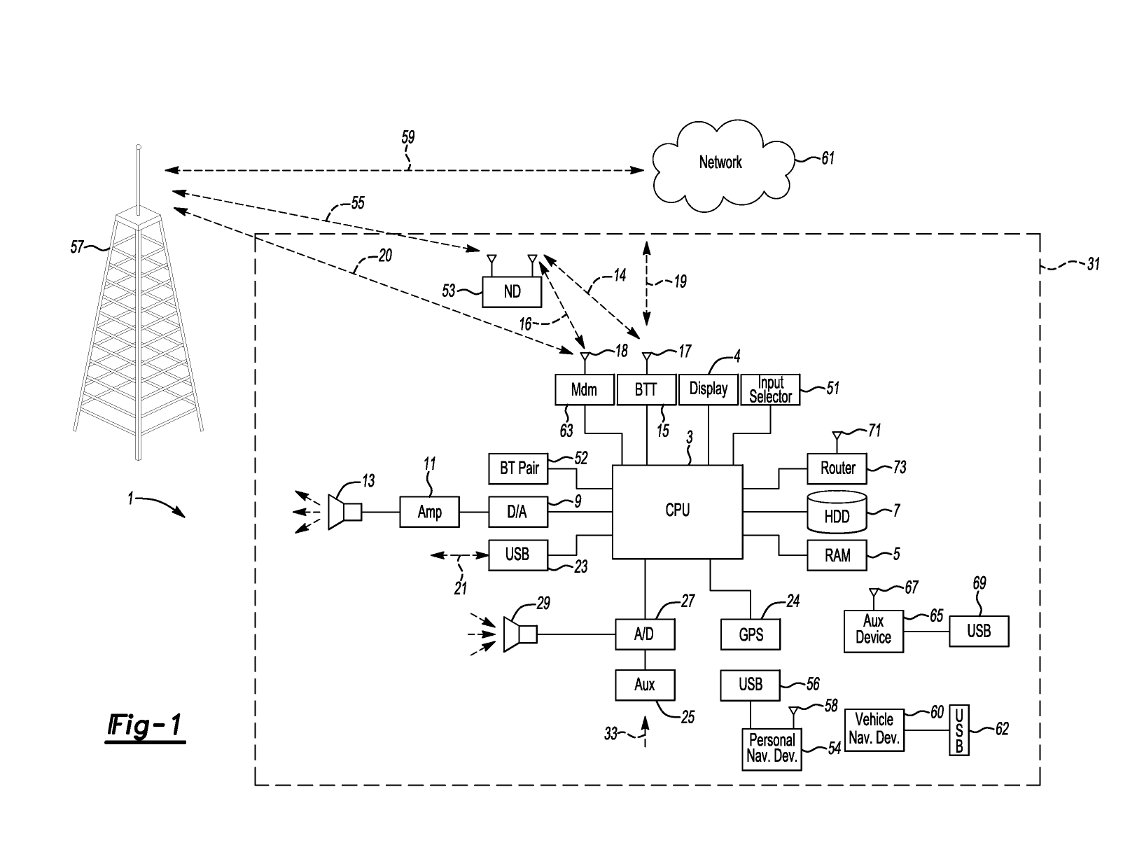

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, audible speech and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory.

The processor is also provided with a number of different inputs allowing the user to interface with the processor. In this illustrative embodiment, a microphone 29, an auxiliary input 25 (for input 33), a USB input 23, a GPS input 24 and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a WiFi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include WiFi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of with Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (firewire), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

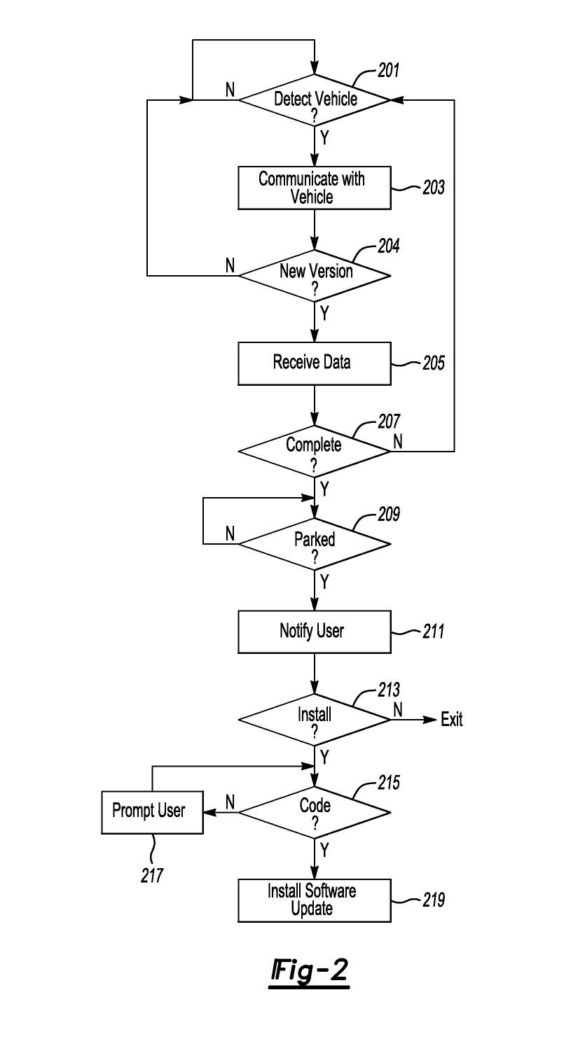

FIG. 2 shows an illustrative example of a software update distribution process. In this example, a illustrative, non-limiting system for sending, receiving and updating software changes is shown. The exemplary process can be used, for example, to securely update and install a change to vehicle software without requiring the user to visit a dealer or download an update to a portable storage device and interface the device with a vehicle. Further, the system can be used as a fast, reliable distribution method for software updates.

In this illustrative example, the exemplary process is running on a plurality of vehicles traveling on roads in a given area. In a particular, example vehicle, the process uses a vehicular transceiver, such as a WiFi transceiver or other transceiver capable of establishing local, wireless communication with another vehicle's transceiver. Because both endpoints of the network are known, at least some degree of reliability of a source of data can be established.

If the example vehicle's process detects another vehicle 201, communication is established 203. Otherwise, the example vehicle's process continues to search for vehicles with which communication can be established until one is detected.

Once communication has been established with the other vehicle, in this illustrative embodiment, the process determines if there are any elements of software available on the new vehicle 204 corresponding to a new version of a module update or other data that the example vehicle does not currently possess and would like to possess.

In this embodiment, software is conveyed between a vehicle in a bit torrent manner. If a piece of software is divided into, for example, 100 parts, any number of vehicles may be carrying any number of individual parts. As the vehicles pass each other and communicate, those parts are conveyed between vehicles, gradually filling in the gaps. Further, the process can accelerate as time progresses, since each vehicle will carry an ever increasing amount of the code.

Of course, since vehicles often are only in proximity for a limited period of time, and traveling at high speeds, it may be the case that only a small amount of data can be transferred. This could be random or requested by the receiving vehicle, for example. Even if only a small amount can be transferred, numerous transfers over the course of a drive or several drives can still swiftly result in the aggregation of an entire software or data update.

In this exemplary process, the example vehicle's process checks for new software on the other vehicle before receiving data, but in another example the example vehicle may simply receive data from every vehicle it passes with which it can communicate, and the data can be sorted on board and vetted for usefulness.

In this exemplary illustration, if the other vehicle has new data that the example vehicle would like to possess, the example vehicle receives one or more elements of data from the other vehicle 205. In this example, once the data reception is complete (note, the communication may also result in the transfer of data from the example vehicle to the other vehicle), the process checks to see if the updated data is whole 207 (i.e., the entire update has been assembled).

Next, in this example, the process waits until the vehicle is parked 209. Since the vehicle will, in this example, ask the driver for installation permission and possibly require driver input, it may be desirable to wait until the vehicle is in a parked state before asking the driver to interface with a vehicle computing system. In other alternatives, the process may execute updating of software automatically. Of course, if a software module critical or useful to the operation of the vehicle is being updated, and incurs the risk of being offline or corrupted, the process may still wait until the vehicle is parked, so as not to potentially interfere with the vehicle's operation.

Once the vehicle is parked, the process notifies a vehicle operator that a new software update has been received 211. This can be an audible, visible or combination update, utilizing any sensory-detectable output provided in the vehicle, for example. The operator is then given the option to have the update installed 213.

In this example, additional security measures are included in the update process to ensure that a hacker or other malicious entity has not uploaded bad, corrupt or improper data to a vehicle for updating. One protection can occur during transfer, where the transferred data may be encrypted, require a checksum, or utilize other known data protection techniques.

In this process, in addition to any transfer related security protocols, the user is prompted to input a data code. The code can be obtained from a reliable source, such as, but not limited to, an OEM such as the vehicle manufacturer. The user could, for example, be provided with a phone number to call and, for example, a software update code. Inputting the code while on the call, the user could then receive a code to input into the vehicle for confirmation of the update. This input code can be verified 215 and can be used to verify the authenticity and completeness of a software update.

If there is an error with the code, the user could be prompted to re-enter the code 217. If the code and/or the software update are authenticated, the process can proceed with installation of the software update 219. As noted, the process can proceed with the update without user permission, or with user permission and without secondary authentication.

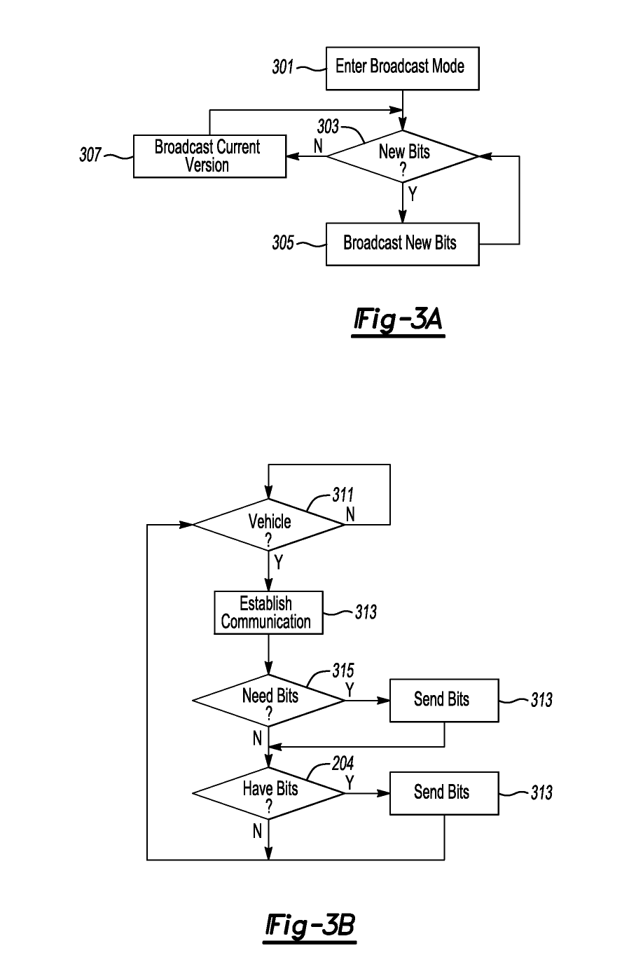

FIG. 3A shows an illustrative example of a software transmission process. There are numerous options for transferring data from one vehicle to another. In at least one model, it is considered that vehicles are typically proximate for only brief periods of time. Accordingly, at least some data transfer techniques considered are designed to transfer data in optimal, if not the most non-redundant methods.

For example, with respect to FIG. 3A, a vehicle process can instruct a broadcast mode 301. In this type of distribution system, vehicles broadcast available data for receipt and use by other vehicles. This process may not require the vehicles to directly communicate before transferring data, instead, the data is simply “there” for passing vehicles to pick up. The vehicles receiving the data may determine if they need the data, for example, by checking an identifier corresponding to a broadcast, or the vehicles may simply receive the data and check it for usefulness at a later point.

Since a vehicle may have more data than can be sent in a single transmission, or in a single data packet, the vehicle may employ any or all of several different broadcast strategies. For example, without limitation, the vehicle may randomly broadcast packets in its possession, it may broadcast the packets in some predetermined order, or it may broadcast some subsection of the packets it possesses in random or predetermined order. It may even be the case that if a vehicle receives or detects that a number of vehicles which it passes are broadcasting a particular packet, that vehicle stops broadcasting that packet for some period, since other vehicles may be “handling” that particular distribution adequately. Various techniques can be used to optimize the transmission of data packets.

In this example, if the vehicle is in broadcast mode, it checks to see if it possesses any “new bits” or new elements of a software update 303. For example, without limitation, if a current software version is version 1.0.3 and the vehicle has elements, but not a complete version of software version 1.0.4, the vehicle “knows” that 1.0.4 is the newer version of the software. In this example, the vehicle will then broadcast only the new bits or elements in its possession 305, to ensure that the latest software is being distributed.

On the other hand, if no bits of a new version are possessed by the vehicle, the vehicle may “assume” that it has the most updated version of a software product in complete form with the version it has currently implemented, and thus will broadcast bits or portions of that version 307. Since other vehicles are capable of determining the appropriateness of received data, it is not a problem if a vehicle is broadcasting an “old” version, it may simply be less efficient. Of course, at any point in this process, if the broadcasting vehicle receives a “new bit” of a newer version, it can switch broadcasting to broadcast the newer version only.

FIG. 3B shows an illustrative example of a second software transmission process. In this illustrative example, two or more vehicles establish communication before broadcasting to convey information relating to needed or possessed data elements or bits.

In this example, a first vehicle process continues searching for other vehicles with which communication can be established until one is found 311. Once the other vehicle is found, the process establishes communication with a computing system of the second vehicle 313.

After communication is established, the first vehicle process can determine, through communication with the second vehicle, whether or not the other vehicle needs any of the data that the first vehicle possesses 315. If data is needed, the first vehicle can transmit one or more needed portions of data to the other vehicle 317. Next, or simultaneously, using bi-directional communication, the vehicle process can determine if the other vehicle has any bits that the first vehicle needs 319. If so, the vehicle can receive one or more data elements from the other vehicle. In one example, the first vehicle can send all data and then receive all data, in another example the data transfer is simultaneous using bi-directional communication, and in a third non-limiting example, the vehicles alternate exchanging bits until all needed data is transferred or communication is lost. Other suitable methods of transfer may also be applied.

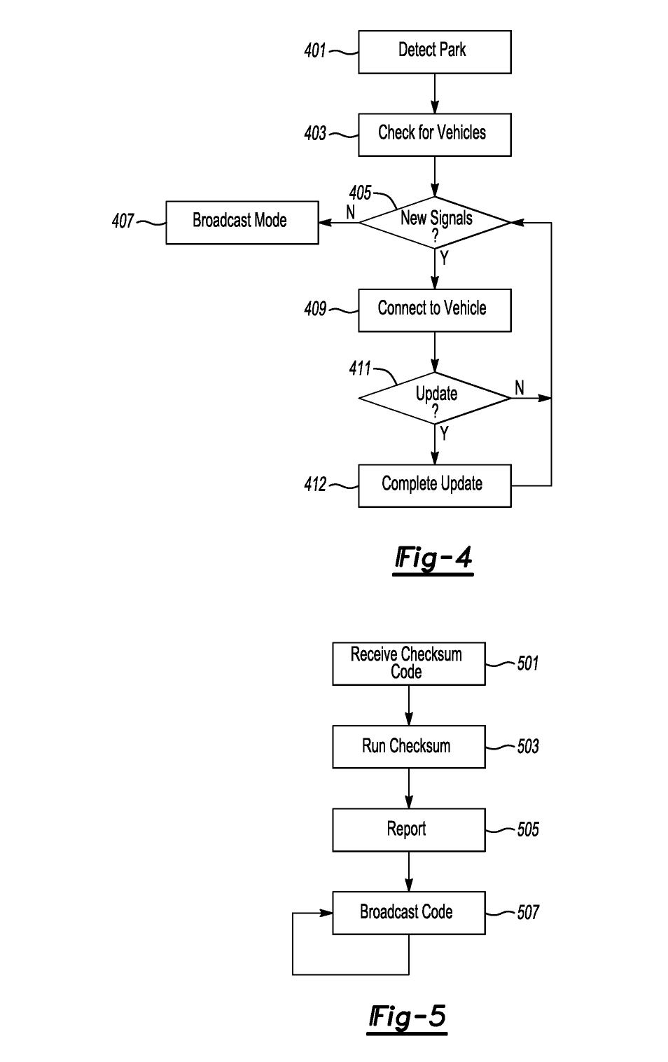

FIG. 4 shows an illustrative example of a software update process. In this exemplary process, the vehicle attempts an update process while in a parked state. Since it may be communicating with one or more other parked vehicles, this can be an opportunity for a more significant portion of data to be transferred. Once the vehicle process detects a park state 401, it checks for surrounding vehicles in a broadcast or communication state 403.

If there is at least one connectable signal 405, the process connects to that vehicle 409 and checks to see if there is any software update possessed by that vehicle that the example vehicle needs 411. Although not shown, the example vehicle process could also offer software updates to the vehicle to which it is connected. If there is desired software available over the communication connection, the process proceeds to receive as much of the desired data as possible 413. Since one or both of the vehicles may not be moving (and thus, disrupting the connection), it may be possible to receive all of the needed data from the other vehicle. Once the reception is complete, or as complete as possible, the vehicle continues to look for other vehicles with which it can communicate 405.

If no other vehicles are available, the parked example vehicle may itself enter a broadcast mode to supply its own updates to later arriving or passing vehicles. Depending on how much power is required, this process can be temporary, for a fixed duration, or for the entire time the vehicle is in a parked state. Allowing vehicles to communicate in this manner means that every vehicle with this capability is a constant or semi-constant transmitter and receiver of information, allowing widespread, fast dissemination of data across a vast network.

FIG. 5 shows an illustrative example of a mesh network polling process. In addition to providing software updates, the mobile mesh network comprised of vehicles constantly entering and exiting the road system can be used for other purposes as well. In this example, localized polling of vehicles can be utilized to detect an onset of a potential problem, allowing a software provider to address the problem proactively, instead of waiting for reports of the problem to arrive.

For example, if a software provider has recently issued an update, they may wish to know the distribution of the update and or whether certain portions of the update are currently operating correctly. Vehicles, specifically selected or selected at random, can begin disseminating a test process or checksum validation code, which can rapidly be spread throughout the network. This can even occur multiple times per day.

As the test code is distributed, each vehicle receiving the code can execute it to produce a reportable result. The results can then be collected remotely or through a re-distribution of the results as additional data between vehicles.

As seen in FIG. 5, a vehicle receives a checksum or other test code from a source 501. The source can be another vehicle or a software provider. The vehicle, assuming the code is complete and usable, executes the test 503 and then, in this example, reports the result back to a known reporting source 507. Additionally, the vehicle continues broadcasting the code to other vehicles 509, allowing localized spreading of the reporting process and report gathering.

Other possible implementations include, but are not limited to, broadcasting of data for subscribers to a service, broadcasting data relating to media, broadcasting alert data, etc.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A computer implemented method comprising:
wirelessly receiving data in a first vehicle from a vehicle computing system in a proximate second vehicle, the data comprising at least a portion of a complete software process;
storing the received data;
evaluating whether the stored data, in conjunction with any previously stored data, constitutes an entirety of the complete software process; and
conditional on the evaluating, executing the complete software process.

2. The method of claim 1, wherein the data is received over a mobile mesh network.

3. The method of claim 1, wherein the software process is a test process.

4. The method of claim 1, wherein the software process is a software update.

5. The method of claim 4, further comprising:
detecting that a vehicle is in a parked state;
notifying a user that the entirety of the complete software process has been stored;
and wherein the executing further includes executing the complete software process after a user has indicated that execution is permissible.

6. The method of claim 5, wherein the executing further includes:
requesting a verification code from the user;
utilizing an input verification code to validate the software update; and
executing the complete software process contingent on the verification of the software update.

7. The method of claim 1, wherein the wirelessly receiving further includes, responsive to a request for specific data, wirelessly receiving at least a portion of the specific data from the proximate vehicle computing system.

8. A system comprising a plurality of vehicles, each having a transceiver and a vehicle computing system, wherein the respective vehicle computing systems are configured to transfer and store portions of a software update therebetween, such that one or more of the vehicles eventually stores an entire version of the software update, having been completely received in portion form from more than one of the plurality of vehicles.

9. The system of claim 8, wherein each vehicle is configured to broadcast any portion of the software update currently stored in a memory of that vehicle.

10. The system of claim 8, wherein at least one of the vehicle computing systems is configured to execute the software update to update a vehicle software module, once the entire version of the software update is stored in a memory of that vehicle.

11. The system of claim 10, wherein at least one of the vehicle computing systems is configured to wait until a vehicle is in a parked state before executing the software update.

12. The system of claim 11, wherein at least one of the vehicle computing systems is configured to wait for user permission before executing the software update.

13. The system of claim 12, wherein at least one of the vehicle computing systems is configured to wait for an input authentication code before executing the software update.

14. The system of claim 8, wherein at least one of the vehicles is configured to randomly broadcast differing portions of the software update at intervals.

15. The system of claim 8, wherein at least one of the vehicles is configured to responsively transfer at least a portion of the software update in response to a request from another of the vehicles.

16. A computer implemented method comprising:
receiving test code from a proximate vehicle computing system;
executing the test code to produce a test result;
reporting the test result back to a known remote server; and
transmitting the received test code to a different proximate vehicle computing system.

17. The method of claim 16, wherein the reporting is done by a vehicle computing system in wireless communication with the remote server through a wireless link established through a wireless device in wireless communication with the vehicle computing system.

18. The method of claim 16, wherein the receiving test code further includes receiving only a portion of test code from a first proximate vehicle computing system, and receiving a remaining portion of test code from one or more other proximate vehicle computing systems.

19. The method of claim 16, wherein the transmitting further includes transmitting a portion of the received test code.

20. The method of claim 19, wherein the transmitting further includes transmitting a received portion of the received test code before a completed version of the test code has been received.
